(19) United States
(12) Patent Application Publication
(10) Pub. No.: US 2007/0101945 A1
(43) Pub. Date: May 10, 2007

(54) Preventing mastitis and providing pathogen control of dairy cattle

(76) Inventor: Jody Shumway, Afton, WY (US)

Correspondence Address: KIRTON & McCONKIE, Suite 1800, 60 East South Temple, Salt Lake City, UT, 84111, US

(21) Appl. No.: 11/268,763

(22) Filed: Nov. 7, 2005

(51) Int. Cl. A01K 29/00

(52) U.S. Cl. 119/670

(57) ABSTRACT

Preventing mastitis and providing pathogen control of dairy animals by applying an ozone treatment to dairy animal teats. An ozonized water solution is prepared and applied to the teats of a dairy cow as part of a pre-milking and/or post-milking process. The ozonized water solution is applied to the dairy cow teats through a variety of techniques, including a dip process (e.g., using a dip cup), a spray process (e.g., using a system having a sprayer) or another application process. The application of ozonized water to dairy cow teats is highly effective in not only sterilization but also in providing a noticeable improvement in the condition of the teat itself.

### BACKGROUND OF THE INVENTION

1. Field of the Invention

The present invention relates to preventing mastitis and providing pathogen control for dairy cattle. In particular, the present invention relates to systems and methods for applying an ozone treatment to animal teats.

2. Background and Related Art

A variety of pre-milking techniques are available to reduce the presence of bacteria. For example, one such technique includes removing hair from dairy cow udders to reduce the amount of dirt and/or manure that adheres to the udder and contaminates milk. Udders that have long hairs attached thereto can prove to be difficult to clean and dry. Dairy cows having wet and/or dirty teats can increase the risk of high bacterial counts in the milk and the probability of intramammary infection.

Another pre-milking technique includes the application of an iodine based solution on dairy cow teats. A similar application of the iodine based solution may also be applied to the teats after the dairy cow has undergone the milking process. However, while the iodine based solution can reduce the presence of bacteria, problems still exist with the use of the solution. For example, over a period of time the iodine based solution can cause a break down in the cow's skin tissue, making the dairy cow teat susceptible to infection and other skin problems.

Thus, while techniques currently exist that are used to reduce the presence of bacteria, challenges still exist. Accordingly, it would be an improvement in the art to augment or even replace current techniques with other techniques.

### SUMMARY OF THE INVENTION

The present invention relates to preventing mastitis and providing pathogen control for dairy cattle. In particular, the present invention relates to systems and methods for applying an ozone treatment to animal teats.

Implementation of the present invention takes place in association with an ozone based application for dairy cattle. In at least some implementations, an ozonized water solution is prepared and applied to the teats of a dairy cow as part of a pre-milking and/or post-milking process. The ozonized water solution is applied to the dairy cow teats through any of a variety of techniques, including a dip process (e.g., using a dip cup), a spray process (e.g., using a system having a sprayer) or another application process. The process of applying ozonized water to dairy cow teats is highly effective for sterilization, and provides a noticeable improvement in the condition of the teat itself. For example, the increased condition of the dairy cow teats is visually noticeable after approximately 7-10 days of applying an ozonized water solution.

Thus, at least some embodiments of the present invention include using an ozone treatment to clean the surface of a teat. Use of the ozone treatment breaks down manure on the teat and provides other cleaning properties. Embodiments of the present invention embrace applying the ozone treatment before and/or after milking a dairy cow. Thus, some embodiments of the present invention embrace a pre-teat dip ozone treatment application and a post teat dip ozone application.

While the methods and processes of the present invention have proven to be particularly useful in the area of sanitizing and conditioning diary cow teats, those skilled in the art will appreciate that the methods and processes can be used in a variety of different applications and on a variety of milk-producing animals to effectively provide such benefits as preventing mastitis and providing pathogen control for the milk-producing animals. Further, those skilled in the art will appreciate that embodiments of the present invention embrace the application of a variety of ozonized solutions, other than ozonized water, to effectively provide such benefits.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative system for producing and providing an ozonized solution for application on a milk producing animal in accordance with an embodiment of the present invention;

FIG. 2 illustrates a representative dip method for applying an ozonized solution to a teat of a milk producing animal in accordance with an embodiment of the present invention; and

FIG. 3 illustrates a representative spray method for applying an ozonized solution to teats of a milk producing animal in accordance with an embodiment of the present invention.

### DETAILED DESCRIPTION OF THE INVENTION

The present invention relates to preventing mastitis of dairy cattle and providing pathogen control for the dairy industry. In particular, the present invention relates to systems and methods for applying an ozone treatment to animal teats.

Embodiments of the present invention embrace an ozone based application for diary cattle. An ozonized solution is prepared and applied to the teats of a dairy cow as part of a pre-milking and/or post-milking process. One example of an ozonized solution is ozonized water. The ozonized water is applied to the dairy cow teats through any of a variety of techniques, including a dip process (e.g., using a dip cup), a spray process (e.g., using a system having a sprayer) or another application process. The process of applying the ozonized water to dairy cow teats is highly effective in not only sterilization but also in providing a noticeable improvement in the condition of the teat itself.

While one example of an ozonized solution is ozonized water, embodiments of the present invention also embrace the application of other solutions comprising ozone. Further, embodiments of the present invention embrace non-liquid solutions comprising ozone.

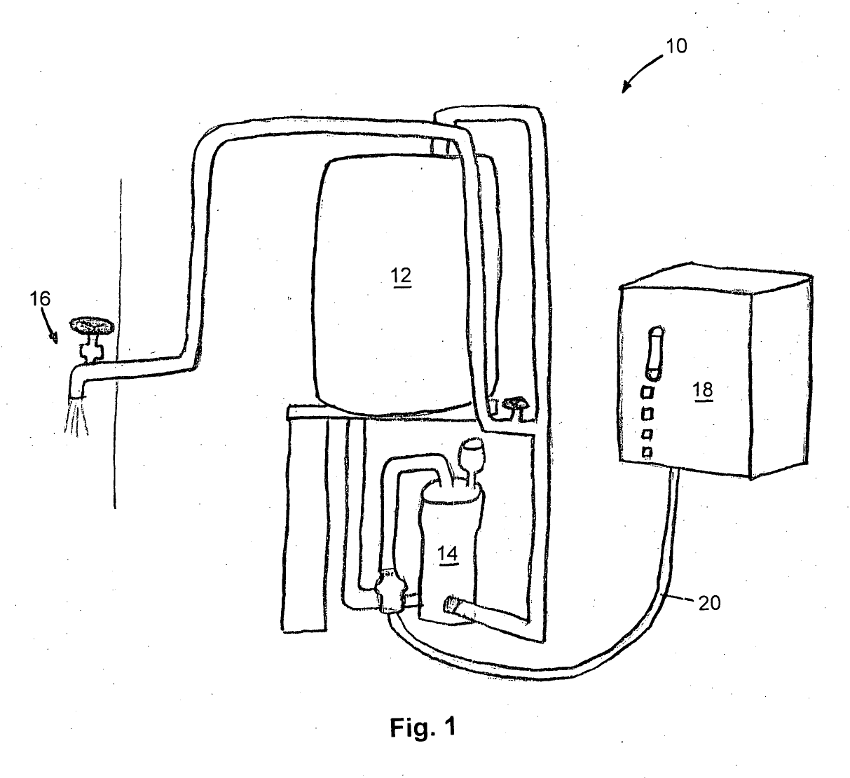

With reference now to FIG. 1, a representative system for producing and providing an ozonized solution for application on a milk producing animal teat is illustrated. In FIG. 1, system 10 includes container 12, pump 14, dispenser 16 and ozone generator 18. Container 12 is a holding tank that contains a solution. In the present embodiment, container 12 contains water that is being re-circulated within system 10 and injected with ozone. The ozone is generated by ozone generator 18 and supplied through hose 20 to re-circulation pump 14. In at least one embodiment, hose 20 is a Teflon® (polytetrafluoroethylene or PTFE) tube. Those skilled in the will appreciate that other materials may be used, including other polymers and/or metals.

The water or other solution is circulated through pump 14. As the water is being circulated, the ozone generated by ozone generator 18 and supplied by hose 20 is injected into the water at pump 14 as the water is being circulated.

In one embodiment, ozone generator 18 provides an amount of ozone to water of system 10 to provide ozonized water at a level of 2.05 ozonization. Those skilled in the art will appreciate that the embodiments of the present invention embrace providing a level of ozonization that is less than or greater than 2.05 ozonization. In addition, in FIG. 1, container 12 is a 50 gallon tank that continues to re-circulate during the entire milking process, keeping the water charged at the 2.05 ozonization level.

In one embodiment, the circulation process of the solution is a continuous process that maintains a charged solution within system 10. In a further embodiment, a measurement device determines the ozonization level and/or maintains the ozonization at a particular level.

Dispenser 16 allows for a user to selectively draw the charged solution comprising ozone from system 10 for selective application. For example, the charged solution may be applied to the dairy cow teats through any of a variety of techniques, including a dip process (e.g., using a dip cup), a spray process (e.g., using a system having a sprayer) or another application process, as will be further discussed below.

While the discussion above includes a solution of water that is injected with ozone, embodiments of the present invention also embrace other solutions, including non-liquid solutions, which are ozonized or otherwise injected with ozone for the application on teats of milk producing animals.

Once the ozonized solution is prepared, the ozonized solution is applied to the teats of a milk producing animal. Thus, for example, in the dairy industry the ozonized solution is applied to the teats of a dairy cow.

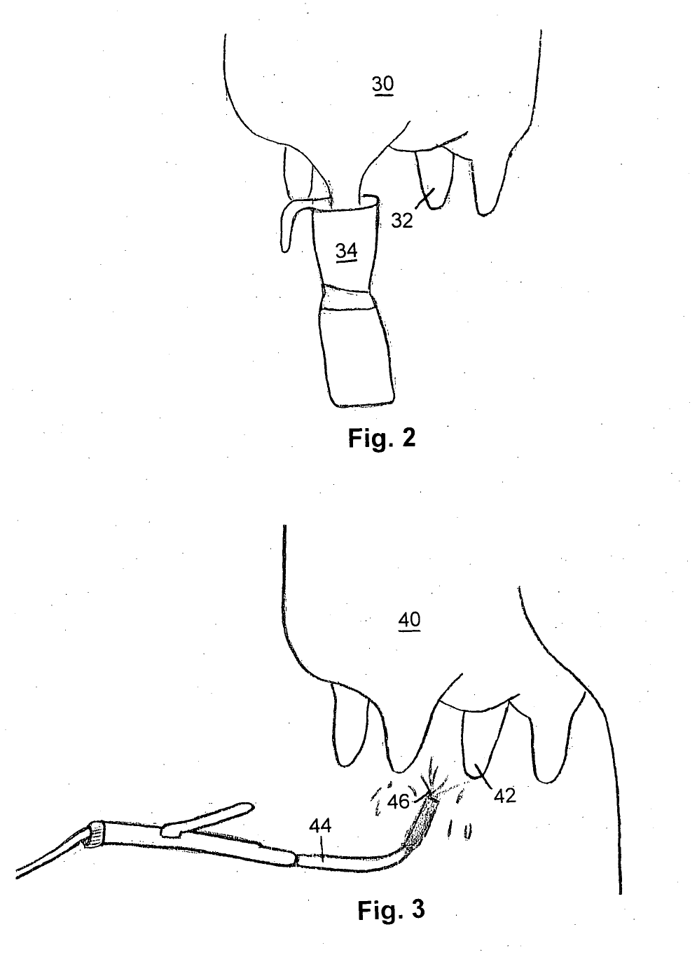

With reference now to FIG. 2, a representative method is illustrated for applying the ozonized solution to a teat of a milk producing animal, such as a dairy cow. In FIG. 2, dairy cow udder 30 comprises a plurality of teats 32. An applicator 34 is used to apply an ozonized solution to teats 32. In FIG. 2, applicator 34 is a dip cup that is configured to contain the ozonized solution. A teat 32 is dipped into applicator 34 to apply an amount of the ozonized solution onto the dipped teat. Applicator 34 is filled with the ozonized solution by dispensing the ozonized solution from a system, such as dispenser 16 of system 10 (see FIG. 1).

In one embodiment, a pre-milking process comprises application of the ozonized solution to only the teats as exposure to the entire udder can be more difficult to dry prior to milking.

Once all of the teats 32 have had the ozonized solution applied thereon as part of the pre-milking process, the teats may be dried, such as by using a clean towel. The dairy cow then undergoes the milking process, such as being attached to a milking machine after milk letdown occurs. Upon completion of the milking process, the teats undergo a post milking application of the ozonized solution.

Thus, at least some embodiments of the present invention embrace applying an ozone treatment before and/or after milking a dairy cow. For example in one embodiment, a pre-teat dip ozone treatment application and a post teat dip ozone application are performed.

With reference now to FIG. 3, a representative spray method for applying the ozonized solution to dairy cow teats is illustrated. In FIG. 3, udder 40 comprises a plurality of teats 42. An applicator 44 sprays the ozonized solution 46 onto the teats 42. Applicator 44 is configured to selectively attach to a dispenser, such as dispenser 16 of FIG. 1.

While FIG. 2 illustrates a representative dip method for applying an ozonized solution and FIG. 3 illustrates a representative spray method for applying an ozonized solution, those skilled in the art will appreciate that embodiments of the present invention further embrace other manners or techniques for applying an ozonized solution to a milk producing animal.

In one embodiment, a dip method is used as a pre-milking process for applying an ozonized solution to a dairy cow teat and a spray method is used to apply the ozonized solution to the dairy cow teat as a post milking process. This embodiment includes such benefits of facilitating drying of the teats prior to the milking process, and cleaning and/or sealing the entire udder and teat area after the milking process.

Use of the ozonized solution has a variety of benefits. For example, the ozonized solution provides healing faculties and is soothing rather than harsh to the teat, and provides quicker and enhanced healing to the cow teat. Additionally, use of the ozonized solution prevents mastitis and/or eliminates pathogens on the teats. Further, embodiments of the present invention reduce and/or eliminate pathogens in the milk.

Thus, as discussed herein, the embodiments of the present invention embrace preventing mastitis and providing pathogen control of dairy animals. In particular, the present invention relates to systems and methods for applying an ozone treatment to animal teats.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A sanitizing and conditioning system for a milk-producing animal, the system comprising:
an ozone generator;
a mechanism coupled to the ozone generator, wherein the mechanism is configured to combine ozone of the ozone generator with a solution for application onto a teat of the milk-producing animal; and
an ozonized solution dispenser coupled to the mechanism, wherein the ozonized solution dispenser is coupled to an ozonized solution applicator that is configured to deliver the ozonized solution to the milk-producing animal teat.

2. A system as recited in claim 1, wherein the milk-producing animal is a dairy cow.

3. A system as recited in claim 2, wherein the mechanism comprises a pump.

4. A system as recited in claim 3, wherein the ozonized solution applicator is a sprayer configured to extend to the teat.

5. A system as recited in claim 2, wherein the solution is water.

6. A method for sanitizing and conditioning a teat of a milk-producing animal, the method comprising:
providing an ozonized solution; and
applying the ozonized solution to a teat of a milk-producing animal.

7. A method as recited in claim 6, wherein the ozonized solution is ozonized water.

8. A method as recited in claim 7, wherein the ozonized water comprises approximately 2.05 ozonization.

9. A method as recited in claim 6, wherein said applying the ozonized solution to a teat of a milk-producing animal comprises a dip method.

10. A method as recited in claim 6, wherein said applying the ozonized solution to a teat of a milk-producing animal comprises a spray method.

11. A method as recited in claim 6, wherein said applying the ozonized solution to a teat of a milk-producing animal comprises at least one of:
using a pre-milking dip method; and
using a post-milking spray method.

12. A method as recited in claim 11, wherein the milk-producing animal is a dairy cow.

13. A method for sterilizing and conditioning a teat of a dairy cow, the method comprising:
providing an ozonized solution; and
applying the ozonized solution to a teat of a dairy cow.

14. A method as recited in claim 13, wherein the ozonized solution is ozonized water.

15. A method as recited in claim 14, wherein the ozonized water comprises approximately 2.05 ozonization.

16. A method as recited in claim 13, wherein said applying the ozonized solution to a teat of a dairy cow comprises a dip method.

17. A method as recited in claim 13, wherein said applying the ozonized solution to a teat of a dairy cow comprises a spray method.

18. A method as recited in claim 13, wherein said applying the ozonized solution to a teat of a dairy cow comprises using a pre-milking dip method.

19. A method as recited in claim 18, wherein said applying the ozonized solution to a teat of a dairy cow further comprises using a post-milking spray method.
